(19) United States
(12) Patent Application Publication
(10) Pub. No.: US 2025/0260455 A1
(43) Pub. Date: Aug. 14, 2025

(54) SYSTEMS AND TECHNIQUES FOR MEASURING AND REPORTING NETWORK CALIBRATION PARAMETERS

(71) Applicant: Apple Inc., Cupertino, CA (US)

(72) Inventors: Huaning Niu, San Jose, CA (US); Ankit Bhamri, Bad Nauheim (DE); Dawei Zhang, Saratoga, CA (US); Haitong Sun, Cupertino, CA (US); Hong He, San Jose, CA (US); Wei Zeng, Saratoga, CA (US); Weidong Yang, San Diego, CA (US)

(21) Appl. No.: 19/043,902

(22) Filed: Feb. 3, 2025

Related U.S. Application Data
(60) Provisional application No. 63/552,784, filed on Feb. 13, 2024.

(51) Int. Cl. H04B 7/06; H04B 17/318; H04W 24/10; H04W 72/21; H04W 76/28

(52) U.S. Cl. CPC H04B 7/0626; H04B 17/328; H04W 24/10; H04W 72/21; H04W 76/28

(57) ABSTRACT

Disclosed are methods, systems, and computer-readable medium to perform operations including: measuring a first Channel State Information Reference Signal (CSI-RS) received from a first transmission reception point (TRP) of a plurality of TRPs; measuring a second CSI-RS received from a second TRP of the plurality of TRPs; determining a time delay and a frequency offset between the first TRP and the second TRP based on the first CSI-RS and the second CSI-RS; and generating a calibration report including the determined time delay and the determined frequency offset for transmission to the first TRP and the second TRP.

### CROSS-REFERENCE TO RELATED APPLICATION

This application claims priority to U.S. Provisional Patent Application No. 63/552,784, filed Feb. 13, 2024, the entire contents of which are incorporated herein by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In general, user equipment (UE) can be configured to measure and report network calibration parameters to a wireless network to facilitate communications between the UE and the wireless network.

For instance, a UE can transmit wireless signals to and/or receive wireless signals from multiple Transmission Reception Points (TRPs) of a wireless network. Due to various factors, the wireless signals may be offset relative to one another with respect to time and frequency/phase. To facilitate the synchronization of the UE with each of the TRPs, the UE can measure network calibration parameters (e.g., time offsets and/or frequency/phase offsets with respect the TRPs) and report the network calibration parameters to the wireless network. Based on the reported network calibration parameters, the wireless network can adjust the transmission of wireless signals to the UE and/or process wireless signals received from the UE to account for the offsets (e.g., such that the UE and the wireless network are synchronized).

In accordance with one aspect of the present disclosure, a method includes: measuring a first Channel State Information Reference Signal (CSI-RS) received from a first transmission reception point (TRP) of a plurality of TRPs; measuring a second CSI-RS received from a second TRP of the plurality of TRPs; determining a time delay and a frequency offset between the first TRP and the second TRP based on the first CSI-RS and the second CSI-RS; and generating a calibration report including the determined time delay and the determined frequency offset for transmission to the first TRP and the second TRP.

Implementations of this aspect can include one or more of the following features.

In some implementations, at least one of: the first CSI-RS is received from a first pre-determined CSI-RS port associated with the first TRP, or the second CSI-RS is received from a second pre-determined CSI-RS port associated with the second TRP.

In some implementations, at least one of: the first CSI-RS is received from a first CSI-RS port associated with the first TRP, where the first CSI-RS port is selected from among a first plurality of ports associated with the first TRP based on signal-to-noise ratios (SNRs) of the first plurality of ports, or the second CSI-RS is received from a second CSI-RS port associated with the second TRP, where the second CSI-RS port is selected from among a second plurality of ports associated with the second TRP based on SNRs of the second plurality of ports.

In some implementations, at least one of: the first CSI-RS port is selected based on a first layer indicator (LI) indicating that the first CSI-RS has the highest SNR from among the first plurality of ports, or the second CSI-RS port is selected based on a second LI indicating that the second CSI-RS has the highest SNR from among the second plurality of ports.

In some implementations, at least one of: the first CSI-RS is received periodically according to at least one of a first pre-determined periodicity or a first pre-determined offset associated with the first TRP, or the second CSI-RS is received periodically according to at least one of a second pre-determined periodicity or a second pre-determined offset associated with the second TRP.

In some implementations, at least one of: the first CSI-RS is received aperiodically according to a first plurality of slots associated with a first set of frequencies, or the second CSI-RS is received aperiodically according to a second plurality of slots associated with a second set of frequencies.

In some implementations, at least one of: the first CSI-RS is a first Tracking Reference Signal (TRS) associated with the first TRP, or the second CSI-RS is a second TRS associated with the second TRP.

In some implementations, the first CSI-RS is received from a first CSI-RS port associated with the first TRP, the first CSI-RS being configured based on a first Channel Measurement Resource (CMR) received from the first TRP, and the second CSI-RS is received from a second CSI-RS port associated with the second TRP, the second CSI-RS being configured based on a second CMR received from the second TRP.

In some implementations, the first CMR and the second CMR are received during a common Connected Mode Discontinuous Reception (CDRX) On-Duration.

In some implementations, the first CMR is associated with a first phase, wherein the second CMR is associated with a second phase, and wherein the first phase and the second phase are continuous.

In some implementations, determining the time delay and the frequency offset between the first TRP and the second TRP includes: selecting one of the first TRP or the second TRP as a reference TRP, selecting the other one of the first TRP and the second TRP as a secondary TRP, determining a time delay of the secondary TRP relative to the reference TRP, and determining a frequency offset of the secondary TRP relative to the reference TRP.

In some implementations, the reference TRP is indicated by a network configuration.

In some implementations, the reference TRP is selected absent a network configuration indicating the reference TRP.

In some implementations, the calibration report is a standalone report.

In some implementations, the calibration report further includes at least one of: a Layer 1 Signal to Interference plus Noise Ratio (L1-SINR) measurement, or a Time-Domain Channel Property (TDCP) measurement.

In some implementations, the method further includes at least one of: causing the calibration report to be transmitted periodically using a Physical Uplink Control Channel (PUCCH), causing the calibration report to be transmitted semi-persistently using the PUCCH, or causing the calibration report to be transmitted semi-persistently using a Physical Uplink Shared Channel (PUSCH).

In some implementations, a periodicity and an offset of the transmission of the calibration report is network configured.

In some implementations, a periodicity and an offset of the transmission of the calibration report is aligned with a Discontinuous Reception (DRX) cycle and an On Duration associated with the DRX cycle.

In some implementations, the calibration report is generated for aperiodic transmission using a Physical Uplink Shared Channel (PUSCH).

In some implementations, the method further includes: determining a first priority associated with the calibration report, determining a second priority associated with a second report, and determining whether to refrain from transmitting the calibration report or the second report based on a comparison of the first priority and the second priority.

In some implementations, the method further includes: determining that the second priority is lower than the first priority, and refraining from transmitting the second report.

In some implementations, the second report includes at least one of a Layer 1 Signal to Interference plus Noise Ratio (L1-SINR) measurement or a Layer 1 Reference Signal Received Power (L1-RSRP) measurement, and the first priority is equal to the second priority.

In some implementations, the second report does not include a Layer 1 Signal to Interference plus Noise Ratio (L1-SINR) measurement or a Layer 1 Reference Signal Received Power (L1-RSRP) measurement, and the first priority is equal to the second priority.

In some implementations, the first report is a standalone time delay and frequency offset report, and the first priority is lower than the second priority.

In another aspect, a system includes one or more computers and one or more storage devices on which are stored instructions that are operable, when executed by the one or more computers, to cause the one or more computers to perform any of the operations described herein.

In another aspect, a non-transitory computer storage medium is encoded with instructions that, when executed by one or more computers, cause the one or more computers to perform any of the operations described herein.

In another aspect, an apparatus includes processing circuitry configured to perform any of the operations described herein.

In another aspect, one or more baseband processors are configured to perform any of the operations described herein.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 illustrates an example system, according to some implementations.

FIG. 3 illustrates another example system, according to some implementations.

FIG. 4 illustrates an example set of resource blocks and CS-RI ports, according to some implementations.

FIG. 5 illustrates another example system, according to some implementations.

FIG. 6 illustrates a flowchart of an example method, according to some implementations.

FIG. 7 illustrates an example user equipment (UE), according to some implementations.

FIG. 8 illustrates an example access node, according to some implementations.

### DETAILED DESCRIPTION

In general, user equipment (UE) can be configured to measure and report network calibration parameters to a wireless network to facilitate communications between the UE and the wireless network.

For instance, a UE can transmit wireless signals to and/or receive wireless signals from multiple Transmission Reception Points (TRPs) of a wireless network (e.g., according to Multi-TRP network architecture). A TRP can refer, for example, to a system or apparatus at a particular physical location that transmits and/or receives wireless signals to other systems or apparatus of a wireless network. Due to various factors, the TRPs (and the wireless signals associated with each of the TRPs) may be offset relative to one another with respect to time and frequency/phase. As examples, TRPs may be offset relative to one another due to differences in the propagation delays between the UE and each of the TRPs, frequency differences between the frequency synthesizers of each of the TRPs, and differences in Doppler effects with respect to each of the TRPs (e.g., depending on the velocity of the UE relative to each of the TRPs).

To facilitate the synchronization of the UE with each of the TRPs, the UE can measure network calibration parameters (e.g., time offsets and/or frequency/phase offsets with respect to the TRPs) and report the network calibration parameters to the wireless network. Based on the reported network calibration parameters, the wireless network can adjust the transmission of wireless signals to the UE and/or process wireless signals received from the UE to account for the offsets (e.g., such that the UE and the wireless network are synchronized).

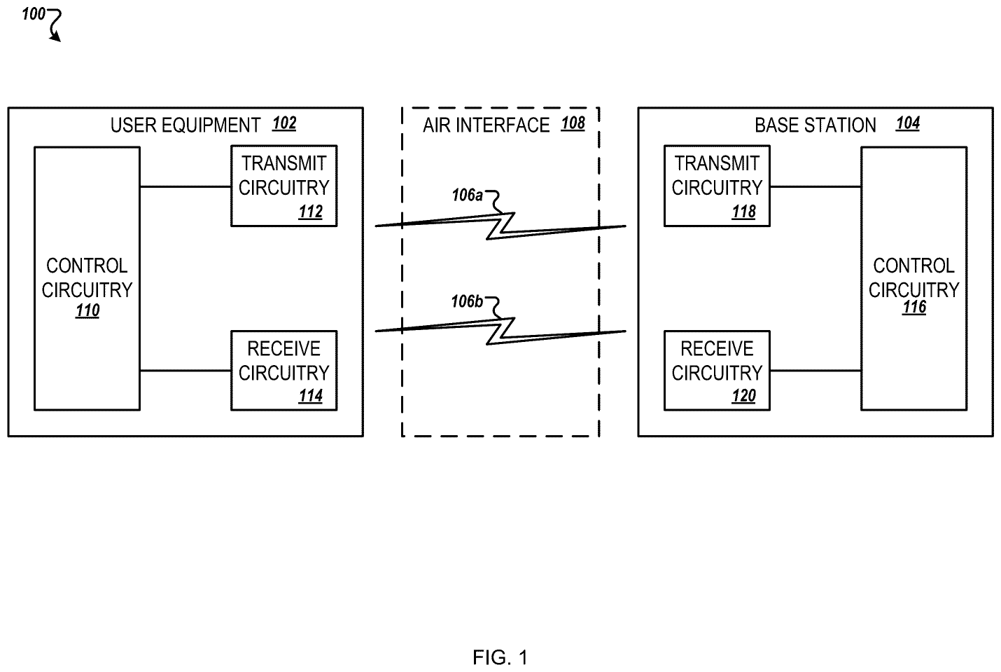

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE. For instance, the control circuitry 110 can be configured to measure network calibration parameters and/or to generate reports signaling those parameters.

The transmit circuitry 112 can perform various operations described in this specification. For example, the transmit circuitry 112 can be configured to transmit reports (e.g., report signaling network calibration parameters) to a wireless network. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can be configured to receive wireless network to facilitate the measurement of network calibration parameters. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

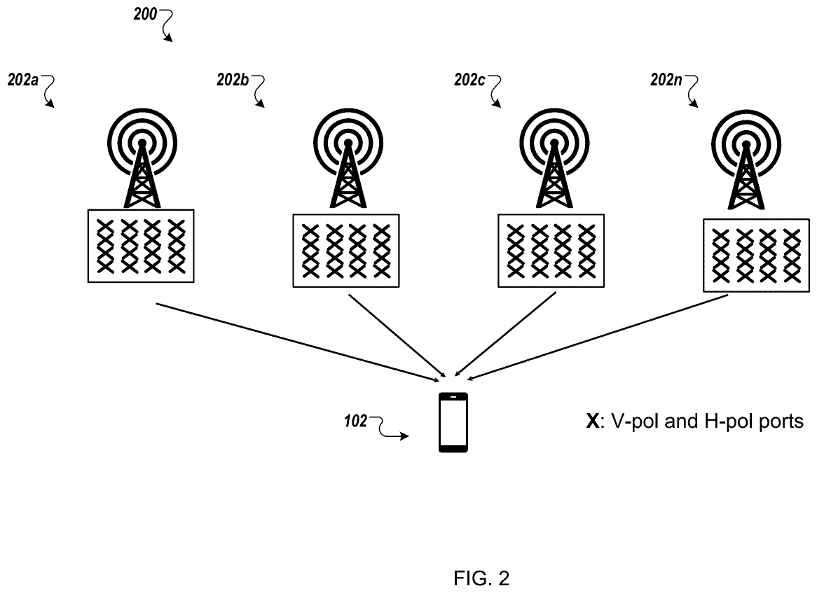

In general, a UE can transmit wireless signals to and/or receive wireless signals from multiple TRPs concurrently, such as in accordance with a Multi-TRP network architecture (e.g., a Coherent Joint Transmission (CJT) Multi-TRP network architecture). As an example FIG. 2, shows an system 200 having a UE 102 and several TRPs 202a-202n. The UE 102 can transmit wireless signals to and/or receive wireless signals from two or more of the TRPs 102a-202-n concurrently to transmit and/or receive data from a wireless network (e.g., one or more base stations communicatively coupled to the TRPs 202a-202n).

Further, each of the TRPs 202a-202n can include multiple ports (e.g., antenna ports) for transmitting and/or receive wireless signals. In general, each of the ports is a logical entity that is associated with a respective set of reference signals and channel model, such that the channel over which a symbol on the port is conveyed can be inferred from the channel over which another symbol on the same port is conveyed.

Each of the TRPs 202a-202n can be associated with multiple respective ports. For instance, each of the TRPs 202a-202n can be associated with multiple horizontally polarized ports (“H-pol” ports) and vertically polarized ports (“V-pol” ports). As an example, as shown in FIG. 2, each of the TRPs 202a-202n can include eight pairs of 16 pairs of H-pol ports and V-pol ports (each pair represented by a respective “X”), totaling 32 ports per TRP.

Further, to facilitate communications with the wireless network, the UE 102 can measure wireless signals received from each of the TRPs 202a-202n, determine one or more network calibration parameters based on the measurements, and signal at least some of parameters to the wireless network (e.g., by transmitting at least some of the parameters to the wireless network via one or more of the TRPs 202a-202n). As an example, the UE 102 can generate Channel State Information (CSI) based on the wireless signal, and transmit a report signaling the CSI (e.g., a CSI report, such as a CJT CSI report) to the wireless network. In general, CSI can represent the known channel properties of a communication link. For example, CSI can describe how a signal propagates from the transmitter to the receiver and can represent the combined effect of, for example, scattering, fading, and power decay with distance. In some implementations, a CSI report can signal CSI regarding one TRP or multiple TRPs concurrently. In some implementations, a CSI report can signal a Rank Indicator (RI) (e.g., representing the number of possible layers for the downlink transmission under specific channel conditions).

Due to various factors, the TRPs (and the wireless signals associated with each of the TRPs) may be offset relative to one another with respect to time and frequency/phase.

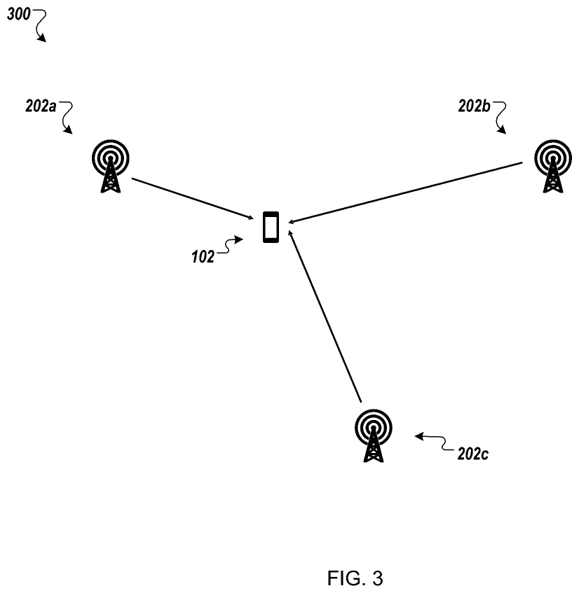

As an example, FIG. 3 shows an example system having a UE 102 and three TRPs 202a-202c. Due to differences in the paths from the UE 102 to each of the TRPs 202a-202c, there may be different propagation delays for wireless signals transmitted between the UE 102 and the TRPS 202a-202c (e.g., resulting in different time offsets between the wireless signals). For example, a wireless signal transmitted on a longer path may exhibit a longer propagation delay, relative to that of a wireless signal transmitted on a shorter path.

Further, in a “non-ideal” backhaul, the TRPs 202a-202c may exhibit further time offsets and frequency/phase offsets relative to one another, due to differences in the configurations of each of the TRPs 202a-202c. For instance, use to differences in the physical configuration of frequency synthesizers of the TRPs 202a-202c (e.g., electrical components used to generate signals having a particular specific frequency or specific frequency composition), TRPs 202a-202c may exhibit frequency/phase offsets relative to one another. As example, two TRPs 202a-202c may be configured to generate wireless signals having the same frequency/phase, but the wireless signals may exhibit different frequencies/phases, due to differences the physical configuration of frequency synthesizers of the TRPs. In at least some implementations, these differences may be specific to a particular cell of the wireless network.

Further, due to the Doppler effect, the frequency of wireless signals transmitted by each of the TRPs 202a-202c can also be offset relative to one another (e.g., depending on the velocity of the UE 102 relative to each of the TRPs 202a-202c). In at least some implementations, these differences may be specific to the UE 102.

The systems and techniques described herein can be used to measure and report time and frequency/phase offsets, particularly those that arise due to differences in the configurations of each of multiple TRPs.

### Examples CSI-RS Configurations for Calibration

In general, a Channel State Information Reference Signal (CSI-RI) port (e.g., antenna port) can be configured to facilitate the measuring and reporting of network calibration parameters. Further, CSI-RI ports can be distributed across different times and/or frequencies to facilitate an accurate estimation of time and frequency/phase offsets under a range of network conditions.

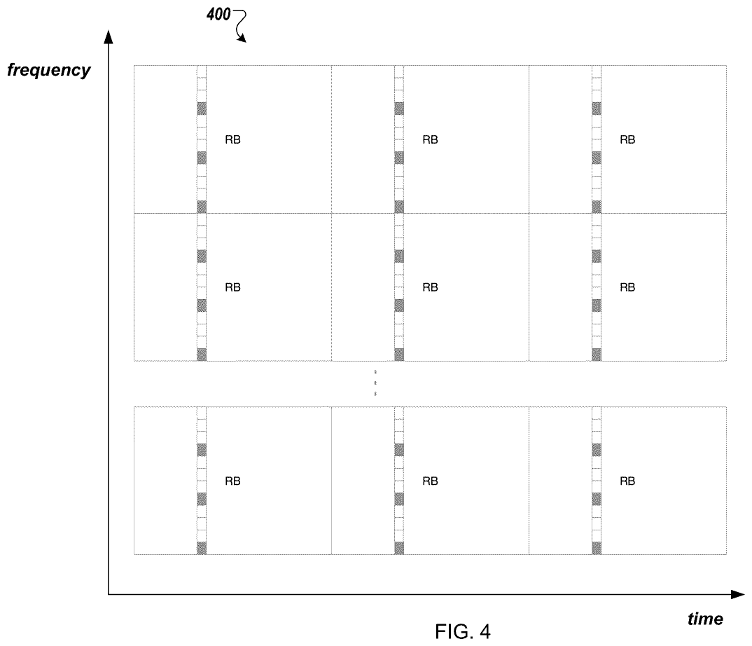

As an example, FIG. 4 shows several resource blocks (RB) 400 that each span a different respective range of times (x-axis) and frequencies (y-axis). CSI-RI ports can be configured for specific combinations of time (e.g., sub-frames) and frequency (represented by shaded blocks) to facilitate an accurate estimation.

In some implementations, at least one CSI-RS port per TRP can be configured for time and/or frequency/phase estimation, such as for a non-ideal backhaul. In some implementations, the CSI-RS port can be configured to provide estimations for up to four TRPs concurrently (e.g., one, two, three, or four TRPs).

In some implementations, the configured CSI-RS port can correspond to the layer (or port) having the highest signal to noise ratio (SNR) for Physical Downlink Shared Channel (PDSCH) transmission. In some implementations, this layer or port can be signaled by a Layer Indicator (LI) transmitted from the UE 102 to the wireless network. This can be beneficial, for example, is it allows estimation to be performed more accurately (e.g., by using layers or ports having a higher SNR for estimation).

In some implementations, for periodic CSI-RS (p-CSI-RS), the periodicity and offset of the p-CSI-RS can be configured per TRP (e.g., by the wireless network). In some implementations, for aperiodic CSI-RS (ap-CSI-RSI), the CSI-RS port can be configured such that it is transmitted over multiple slots to enable frequency offset estimation.

In some implementations, a CSI-RS can be a Tracking Reference Signal (TRS) that is associated with a particular TRP. A TRS is a signal CSI-RS with one port and 3 symbols in between, and can be configured (e.g., by the wireless network) using the syntax “trs-info” (e.g., trs-info=“true”)

In some implementations, an association of CSI-RS ports from different TRPs can be configured (e.g., by the wireless network). For example, in some implementations, an Interference Management Resource (IMR) configuration may not be need for non-ideal backhaul calibration. However, a Channel Measurement Resource (CMR) configuration may be used for non-ideal background calibration. In some implementations, CRMs for different TRPs can be transmitted within the same Connected Mode Discontinuous Reception (CDRX) On-Duration. In some implementations, CMRs for different TRPs can be transmitted in a manner that ensures phase continuity (e.g., by avoiding conditions such as duplexing direction change between CRMs from different TRPs).

### Example UE Estimates for Time and Frequency/Phase Offsets Per TRP:

In general, a UE can estimate time and frequency/phase offsets for a TRP relative to another TRP.

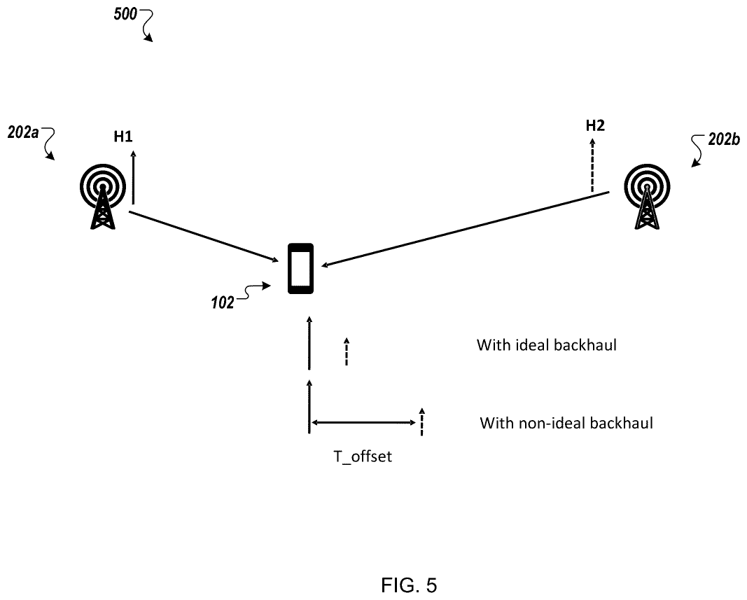

FIG. 5 shows an example system 500 having a UE 102 and two TRPs 202a and 202b. In this example, the TRP 202a transmits a first impulse response channel “H1” to the UE 102, and the TRP 202b transmits a second impulse response channel “H2” to the UE 102.

To estimate a time delay between the TRPs 202a and 202b, the UE 102 measures the CSI-RS transmitted from a reference TRP (e.g., the TRP 202a), and normalizes the time delay to 0. Further, the UE 102 measures the CSI-RS transmitted from the second TRP (e.g., the TRP 202b), estimates the phase ramp across the frequency domain, and estimates of the time delay of TRP 202b. The relative time delay between TRP 202a and TRP 202b (e.g., the difference between the time delays of TRP 202b and TRP 202a, T_{offset}) is provided as feedback to the wireless network (e.g., via a calibration or CSI report).

To estimate a frequency/phase offset between the TRPs 202a and 202b, the UE 102 measures the CSI-RS transmitted from a reference TRP (e.g., the TRP 202a), and determines a phase rotation of the CSI-RS across the time slot. Further, the UE 102 measures the CSI-RS transmitted from the second TRP (e.g., the TRP 202b), and determines a phase rotation of the CSI-RS across the time slot. Based on these measurements, the UE 102 determines the relative frequency/phrase offset between TRP 202a and TRP 202b, and provides the relative frequency/phrase offset as feedback to the wireless network (e.g., via a calibration or CSI report).

### Example Calibration Reports:

In general, the UE can report one or more network calibration parameters to the network. In some implementations, a calibration report (e.g., signaling the time delay and frequency/phase offset to the wireless network) may be referred to as a Time-Frequency Calibration (TFC) report.

In some implementations, the reference TRP (e.g., the TRP that is used as the reference for determining a time delay and/or frequency/phase offset, as described above), can be specified by the wireless network (e.g., by a gNB). Further, the UE 102 can determine the relative time delay and frequency/phase offsets based on the configured reference TRP, and signal these values in a TFC report to the wireless network. In some implementations, depending on the position of the UE, positive and negative offset values may be possible.

In some implementations, the UE 102 can determine the reference TRP (e.g., without relying on the wireless network to configure the reference TRP). Further, the UE 102 can determine the relative time delay and frequency/phase offsets based on the determined reference TRP, and signal these values to the wireless network in a TFC report. In some implementations, the report can indicate values as positive values only. Further, the UE 102 can signal the determined reference TRP and/or the corresponding CSI-RS port to the wireless network in the report.

In some implementations, scaler quantization can be used to reduce the number of bits for feedback (e.g., by quantizing the time delay and frequency/phase offset according to a quantization value).

In some implementations, the TFC report can include information for up to four TRPs concurrently (e.g., one, two, three, or four TRPs).

In some implementations, information regarding the network calibration parameters (e.g., time delay and frequency/phase offset) can be provided to the wireless network in a standalone report or as a part of another report.

In general, reports can be configured by the syntax “reportQuantity.” For example, reportQuantity can be used to specify different types and/or quantities of information in a report, such as a layer indicator (LI), a Layer 1 Signal to Interference plus Noise Ratio (L1-SINR) measurement, or a Layer 1 Reference Signal Received Power (L1-RSRP) measurement, a CSI-RS Interference (CRI) measurement, a Synchronization Signal Block Resource Indicator (SSBRI), “CapabilityIndex,” and/or and a Time-Domain Channel Property (TDCP).

In some implementations, a TFC report can be provided as a standalone report configured in reportQuantity. Example syntax for a report is included below, where “Time-Freq-Calibration” is the time delay and/or frequency/phase offset feedback.

reportQuantity CHOICE {
none NULL,
cri-RI-PMI-CQI NULL,
cri-RI-i1 NULL,
cri-RI-i1-CQI SEQUENCE {
pdsch-BundleSizeForCSI ENUMERATED
{n2, n4} OPTIONAL -- Need S
} ,
cri-RI-CQI NULL,
cri-RSRP NULL,
ssb-Index-RSRP NULL,
cri-RI-LI-PMI-CQI NULL
Time-Freq-Calibration
} ,

In some implementations, a TFC report can combined with another report quantity. For example, in some implementations, the TFC report can be combined with a report that signals L1-SINR (e.g., such that information in the TFC report and the L1-SINR are sent together to the wireless network). The L1-SINR can indicate, for example, the quality of the time and/or frequency estimations in the TFC report.

As another example, in some implementations, the TFC report can be combined with a report that signals a Time-Domain Channel Property (TDCP), such that the impact of Doppler can be separated form the time and frequency/phase estimations for calibration.

Example syntax for combining the TFC report with another report is included below.

reportQuantity CHOICE {
none NULL,
cri-RI-PMI-CQI NULL,
cri-RI-i1 NULL,
cri-RI-i1-CQI SEQUENCE {
pdsch-BundleSizeForCSI ENUMERATED
{n2, n4} OPTIONAL -- Need S
} ,
cri-RI-CQI NULL,
cri-RSRP NULL,
ssb-Index-RSRP NULL,
cri-RI-LI-PMI-CQI NULL
cri-RI-PMI-CQI_TFC NULL,
cri-RI-i1_TFC NULL,
cri-RI-i1-CQI SEQUENCE {
pdsch-BundleSizeForCSI ENUMERATED
{n2, n4} OPTIONAL -- Need S
} ,
cri-RI-CQI_TFC NULL,
cri-RSRP_TFC NULL,
ssb-Index-RSRP_TFC NULL,
cri-RI-LI-PMI-CQI_TFC NULL

### Example Report Types:

In general, a TFC report can be provided to the wireless network using various wireless channels, depending on the particular network configuration.

For example, in at least some implementations, a TFC report for periodic-CSI (p-CSI) can be provided to the wireless network on a Physical Uplink Control Channel (PUCCH).

As another example, in at least some implementations, a TFC report for semi-periodic CSI (sp-CSI) can be provided to the wireless network on a PUCCH.

As another example, in at least some implementations, a TFC report for sp-CSI can be provided to the wireless network on a Physical Uplink Shared Channel (PUSCH).

As another example, in at least some implementations, a TFC report for aperiodic CSI (ap-CSI) can be provided to the wireless network on a PUSCH.

In some implementation, for periodic and semi-persistent PUCCH/PUSCH TFC reports, the periodicity and offset of the reports can be configured (e.g., by the wireless network). Further, periodicity and offset of the reports can be aligned with aligned with a Discontinuous Reception (DRX) cycle and an On Duration associated with the DRX cycle. Further, when a Wake Up Signal (WUS) (e.g., DCI 2-6) is configured and transmitted, the UE 102 can skip the particular report to save power.

Further, different levels of frequency granulation can be used in a TFC report. For example, in some implementations, for wideband communications, the TFC report can granulate frequency by assigned one value per uplink bandwidth part (UL-BWP). As another example, in some implementations, frequency can be granulated according to subband.

### Example Report Prioritization and Omission:

In general, reports (e.g., CSI) can be prioritized relative to one another. Further, a report can be omitted (e.g., not transmitted by the UE to the wireless network) if certain conditions are met.

For example, each CSI report can be associated with respective priority value

$$P r {i}_{iCSI} ( y , k , c , s ) = 2 \cdot {N}_{c e l l s} \cdot {M}_{s} \cdot y + {N}_{c e l l s} \cdot {M}_{s} \cdot k + {M}_{s} \cdot c + s$$

Where:
y=0 for an aperiodic CSI report to be carried on a physical uplink shared channel (PUSCH),
y=1 for a semi-persistent CSI report to be carried on the PUSCH,
y=2 for a semi-persistent CSI report to be carried on a physical uplink control channel (PUCCH),
y=3 for a periodic CSI report to be carried on the PUCCH;
k=0 for a CSI report which carries the L1-RSRP, and
k=1 for a CSI report which does not carry the L1-RSRP;
c denotes a serving cell index and N_{cells} denotes a value of a higher layer parameter maxNrofServingCells; and
s denotes a reportConfigID and Mₛ denotes a value of the higher layer parameter maxNrofCSI-ReportConfigurations.

A first CSI report is said to have priority over second CSI report if the associated Pri_{iCSI}(y, k, c, s) value is lower for the first CSI report than for the second CSI report. When two reports collide, the lower priority CSI report can be dropped or omitted (e.g., such that it is not transmitted from the UE to the wireless network).

In some implementations, the priority of a TFC report can be k=0 (e.g., such that the TFC report has the same priority as a CSI report containing L1-RSRP and/or L1-SINR feedback).

In some implementations, the priority of a TFC report can be k=1 (e.g., such that the TFC report has the same priority as a CSI report that does not contain L1-RSRP or L1-SINR feedback).

In some implementations, the priority of a TFC report can be k=2 (e.g., such that the TFC report has the lowest priority). This priority can be assigned, for example, when the TFC report is reported separately (e.g., as a standalone report), as the base station or eNB can obtain the TFC report from other UEs, as well.

### Example Methods:

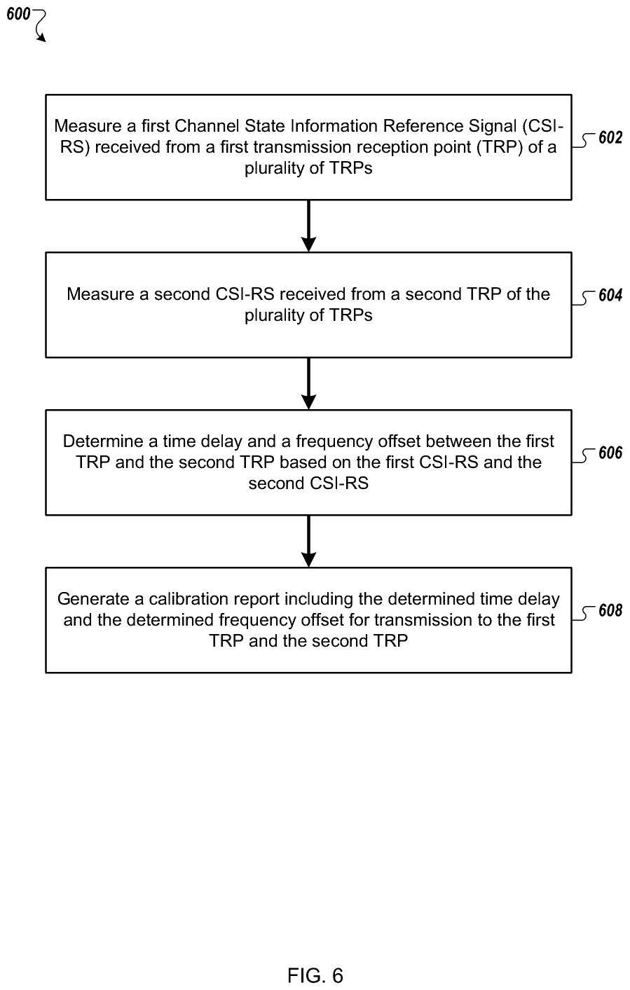

FIG. 6 illustrates a flowchart of an example method 600, according to some implementations. For clarity of presentation, the description that follows generally describes method 600 in the context of the other figures in this description. For example, method 600 can be performed by UE 102 of FIGS. 1-3 and 5. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order.

According to the method 600, a device measures a first Channel State Information Reference Signal (CSI-RS) received from a first transmission reception point (TRP) of a plurality of TRPs (602).

The device measures a second CSI-RS received from a second TRP of the plurality of TRPs (604).

In some implementations, the first CSI-RS can be received from a first pre-determined CSI-RS port associated with the first TRP. In some implementations, the second CSI-RS can be received from a second pre-determined CSI-RS port associated with the second TRP.

In some implementations, the first CSI-RS can be received from a first CSI-RS port associated with the first TRP. Further, the first CSI-RS port can be selected from among a first plurality of ports associated with the first TRP based on signal-to-noise ratios (SNRs) of the first plurality of ports. The first CSI-RS port can be selected based on a first layer indicator (LI) indicating that the first CSI-RS has the highest SNR from among the first plurality of ports.

In some implementations, the second CSI-RS can be received from a second CSI-RS port associated with the second TRP. Further, the second CSI-RS port can be selected from among a second plurality of ports associated with the second TRP based on SNRs of the second plurality of ports. The second CSI-RS port can be selected based on a second LI indicating that the second CSI-RS has the highest SNR from among the second plurality of ports.

The device determines a time delay and a frequency offset between the first TRP and the second TRP based on the first CSI-RS and the second CSI-RS (606).

In some implementations, the time delay and the frequency offset between the first TRP and the second TRP can be determined by selecting one of the first TRP or the second TRP as a reference TRP, selecting the other one of the first TRP and the second TRP as a secondary TRP, determining a time delay of the secondary TRP relative to the reference TRP, and determining a frequency offset of the secondary TRP relative to the reference TRP.

In some implementations, the reference TRP can be indicated by a network configuration.

In some implementations, the reference TRP can be selected absent a network configuration indicating the reference TRP.

The device generates a calibration report including the determined time delay and the determined frequency offset for transmission to the first TRP and the second TRP (608).

In some implementations, the calibration report can be a standalone report.

In some expectations, the calibration report can additionally include a Layer 1 Signal to Interference plus Noise Ratio (L1-SINR) measurement and/or a Time-Domain Channel Property (TDCP) measurement.

In some implementations, the first CSI-RS can be received periodically according to a first pre-determined periodicity and/or a first pre-determined offset associated with the first TRP.

In some implementations, the second CSI-RS can be received periodically according to a second pre-determined periodicity and/or a second pre-determined offset associated with the second TRP.

In some implementations, the first CSI-RS can be received aperiodically according to a first plurality of slots associated with a first set of frequencies.

In some implementations, the second CSI-RS can be received aperiodically according to a second plurality of slots associated with a second set of frequencies.

In some implementations, the first CSI-RS can be a first Tracking Reference Signal (TRS) associated with the first TRP.

In some implementations, the second CSI-RS can be a second TRS associated with the second TRP.

In some implementations, the first CSI-RS can be received from a first CSI-RS port associated with the first TRP. The first CSI-RS can be configured based on a first Channel Measurement Resource (CMR) received from the first TRP.

In some implementations, the second CSI-RS can be received from a second CSI-RS port associated with the second TRP. The second CSI-RS can be configured based on a second CMR received from the second TRP.

In some implementations, the first CMR and the second CMR can be received during a common Connected Mode Discontinuous Reception (CDRX) On-Duration.

In some implementations, the first CMR can be associated with a first phase, the second CMR can be associated with a second phase, and the first phase and the second phase can be continuous.

In some implementations, the method 600 can also include causing the calibration report to be transmitted periodically using a Physical Uplink Control Channel (PUCCH), causing the calibration report to be transmitted semi-persistently using the PUCCH, and/or causing the calibration report to be transmitted semi-persistently using a Physical Uplink Shared Channel (PUSCH).

In some implementations, a periodicity and an offset of the transmission of the calibration report can be network configured.

In some implementations, a periodicity and an offset of the transmission of the calibration report can be aligned with a Discontinuous Reception (DRX) cycle and an On Duration associated with the DRX cycle.

In some implementations, the calibration report can be generated for aperiodic transmission using a Physical Uplink Shared Channel (PUSCH).

In some implementations, the method 600 can also include determining a first priority associated with the calibration report, determining a second priority associated with a second report, and determining whether to refrain from transmitting the calibration report or the second report based on a comparison of the first priority and the second priority.

In some implementations, the device can determine that the second priority is lower than the first priority, and refrain from transmitting the second report.

In some implementations, the second report can include a Layer 1 Signal to Interference plus Noise Ratio (L1-SINR) measurement and/or a Layer 1 Reference Signal Received Power (L1-RSRP) measurement. Further, the first priority can be equal to the second priority.

In some implementations, the second report does not include a Layer 1 Signal to Interference plus Noise Ratio (L1-SINR) measurement or a Layer 1 Reference Signal Received Power (L1-RSRP) measurement. Further, the first priority can be equal to the second priority.

In some implementations, the first report can be a standalone time delay and frequency offset report. Further, the first priority can be lower than the second priority.

The example method 600 shown in FIG. 6 can be modified or reconfigured to include additional, fewer, or different steps (not shown in FIG. 6), which can be performed in the order shown or in a different order.

### Example Devices:

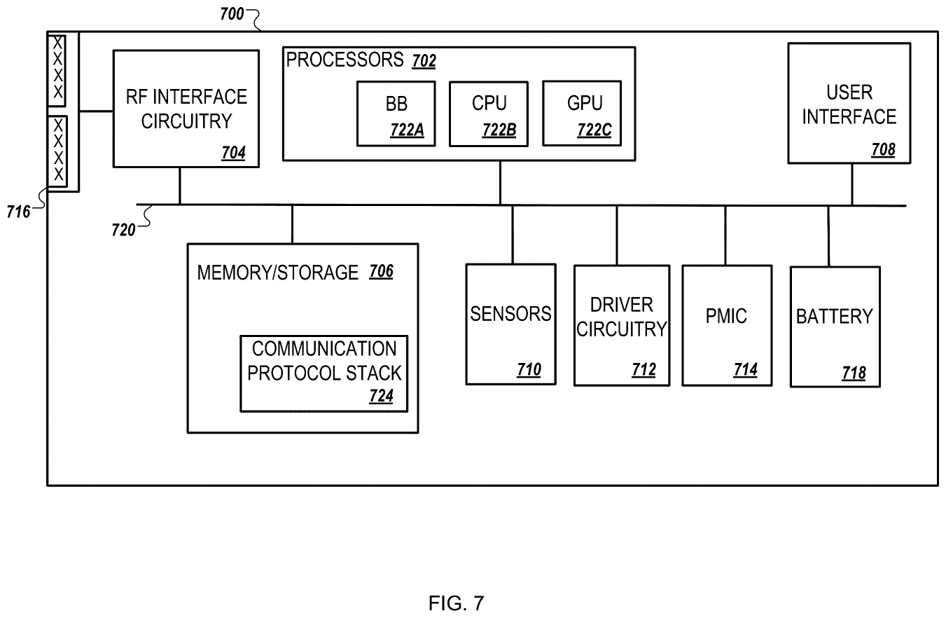

FIG. 7 illustrates an example UE 700, according to some implementations. The UE 700 may be similar to and substantially interchangeable with UE 102 of FIG. 1.

The UE 700 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 700 may include processors 702, RF interface circuitry 704, memory/storage 706, user interface 708, sensors 710, driver circuitry 712, power management integrated circuit (PMIC) 714, one or more antenna(s) 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc., that allows various circuit components (on common or different chips or chipsets) to interact with one another.

The processors 702 may include processor circuitry such as, for example, baseband processor circuitry (BB) 722A, central processor unit circuitry (CPU) 722B, and graphics processor unit circuitry (GPU) 722C. The processors 702 may include any type of circuitry or processor circuitry that executes or otherwise operates computer-executable instructions, such as program code, software modules, or functional processes from memory/storage 706 to cause the UE 700 to perform operations as described herein.

In some implementations, the baseband processor circuitry 722A may access a communication protocol stack 724 in the memory/storage 706 to communicate over a 3GPP compatible network. In general, the baseband processor circuitry 722A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 706 may include one or more non-transitory, computer-readable media that includes instructions (for example, communication protocol stack 724) that may be executed by one or more of the processors 702 to cause the UE 700 to perform various operations described herein. The memory/storage 706 include any type of volatile or non-volatile memory that may be distributed throughout the UE 700. In some implementations, some of the memory/storage 706 may be located on the processors 702 themselves (for example, L1 and L2 cache), while other memory/storage 706 is external to the processors 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 716 and proceed to filter and amplify (with a low-noise amplifier) the signal. The signal may be provided to a receiver of the transceiver that downconverts the RF signal into a baseband signal that is provided to the baseband processor of the processors 702.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 716. In various implementations, the RF interface circuitry 704 may be configured to transmit/receive signals in a manner compatible with NR access technologies.

The antenna(s) 716 may include one or more antenna elements to convert electrical signals into radio waves to travel through the air and to convert received radio waves into electrical signals. The antenna elements may be arranged into one or more antenna panels. The antenna(s) 716 may have antenna panels that are omnidirectional, directional, or a combination thereof to enable beamforming and multiple input, multiple output communications. The antenna(s) 716 may include microstrip antennas, printed antennas fabricated on the surface of one or more printed circuit boards, patch antennas, phased array antennas, etc. The antenna(s) 716 may have one or more panels designed for specific frequency bands including bands in FR1 or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in its environment and send the information (sensor data) about the detected events to some other device, module, subsystem, etc. Examples of such sensors include, inter alia, inertia measurement including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensors 710 and control and allow access to sensors 710, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processors 702, the PMIC 714 may control power-source selection, voltage scaling, battery charging, or DC-to-DC conversion.

In some implementations, the PMIC 714 may control, or otherwise be part of, various power saving mechanisms of the UE 700. A battery 718 may power the UE 700, although in some examples the UE 700 may be mounted deployed in a fixed location, and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

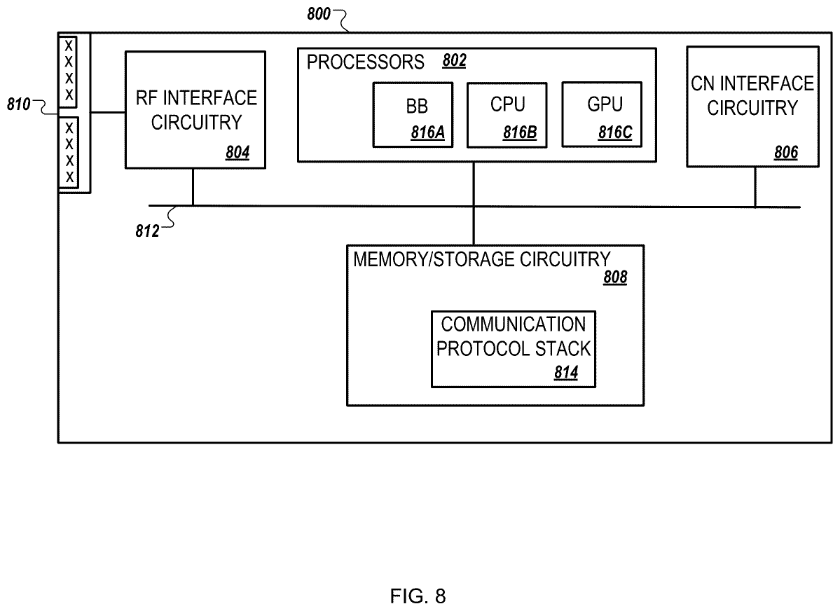

FIG. 8 illustrates an example access node 800 (e.g., a base station or gNB), according to some implementations. The access node 800 may be similar to and substantially interchangeable with base station 104. The access node 800 may include processors 802, RF interface circuitry 804, core network (CN) interface circuitry 806, memory/storage circuitry 808, and one or more antenna(s) 810.

The components of the access node 800 may be coupled with various other components over one or more interconnects 812. The processors 802, RF interface circuitry 804, memory/storage circuitry 808 (including communication protocol stack 814), antenna(s) 810, and interconnects 812 may be similar to like-named elements shown and described with respect to FIG. 7. For example, the processors 802 may include processor circuitry such as, for example, baseband processor circuitry (BB) 816A, central processor unit circuitry (CPU) 816B, and graphics processor unit circuitry (GPU) 816C.

The CN interface circuitry 806 may provide connectivity to a core network, for example, a 5th Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In V2X scenarios, the access node 800 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

### EXAMPLES

In the following sections, further exemplary embodiments are provided.
Example A1 includes a method comprising: measuring a first Channel State Information Reference Signal (CSI-RS) received from a first transmission reception point (TRP) of a plurality of TRPs; measuring a second CSI-RS received from a second TRP of the plurality of TRPs; determining a time delay and a frequency offset between the first TRP and the second TRP based on the first CSI-RS and the second CSI-RS; and generating a calibration report comprising the determined time delay and the determined frequency offset for transmission to the first TRP and the second TRP.
Example A2 includes the method of Example A1. Further, at least one of: the first CSI-RS is received from a first pre-determined CSI-RS port associated with the first TRP, or the second CSI-RS is received from a second pre-determined CSI-RS port associated with the second TRP.
Example A3 includes the method of Example A1. Further, at least one of: the first CSI-RS is received from a first CSI-RS port associated with the first TRP, wherein the first CSI-RS port is selected from among a first plurality of ports associated with the first TRP based on signal-to-noise ratios (SNRs) of the first plurality of ports, or the second CSI-RS is received from a second CSI-RS port associated with the second TRP, wherein the second CSI-RS port is selected from among a second plurality of ports associated with the second TRP based on SNRs of the second plurality of ports.
Example A4 includes the method of Example A3. Further, at least one of: the first CSI-RS port is selected based on a first layer indicator (LI) indicating that the first CSI-RS has the highest SNR from among the first plurality of ports, or the second CSI-RS port is selected based on a second LI indicating that the second CSI-RS has the highest SNR from among the second plurality of ports.
Example A5 includes the method of Example A1. Further, at least one of: the first CSI-RS is received periodically according to at least one of a first pre-determined periodicity or a first pre-determined offset associated with the first TRP, or the second CSI-RS is received periodically according to at least one of a second pre-determined periodicity or a second pre-determined offset associated with the second TRP.
Example A6 includes the method of Example A1. Further, at least one of: the first CSI-RS is received aperiodically according to a first plurality of slots associated with a first set of frequencies, or the second CSI-RS is received aperiodically according to a second plurality of slots associated with a second set of frequencies.
Example A7 includes the method of Example A1. Further, at least one of: the first CSI-RS is a first Tracking Reference Signal (TRS) associated with the first TRP, or the second CSI-RS is a second TRS associated with the second TRP.
Example A8 includes the method of Example A1. Further, the first CSI-RS is received from a first CSI-RS port associated with the first TRP, the first CSI-RS being configured based on a first Channel Measurement Resource (CMR) received from the first TRP, and the second CSI-RS is received from a second CSI-RS port associated with the second TRP, the second CSI-RS being configured based on a second CMR received from the second TRP.
Example A9 includes the method of Example A8. Further, the first CMR and the second CMR are received during a common Connected Mode Discontinuous Reception (CDRX) On-Duration.
Example A10 includes the method of Example A8. Further, the first CMR is associated with a first phase, wherein the second CMR is associated with a second phase, and wherein the first phase and the second phase are continuous.
Example A11 includes the method of Example A1. Further, determining the time delay and the frequency offset between the first TRP and the second TRP comprises: selecting one of the first TRP or the second TRP as a reference TRP, selecting the other one of the first TRP and the second TRP as a secondary TRP, determining a time delay of the secondary TRP relative to the reference TRP, and determining a frequency offset of the secondary TRP relative to the reference TRP.
Example A12 includes the method of Example All. Further, the reference TRP is indicated by a network configuration.
Example A13 includes the method of Example A11. Further, the reference TRP is selected absent a network configuration indicating the reference TRP.
Example A14 includes the method of Example A1. Further, the calibration report is a standalone report.
Example A15 includes the method of Example A1. Further, the calibration report further comprises at least one of: a Layer 1 Signal to Interference plus Noise Ratio (L1-SINR) measurement, or a Time-Domain Channel Property (TDCP) measurement.
Example A16 includes the method of Example A1. Further, the method comprises at least one of: causing the calibration report to be transmitted periodically using a Physical Uplink Control Channel (PUCCH), causing the calibration report to be transmitted semi-persistently using the PUCCH, or causing the calibration report to be transmitted semi-persistently using a Physical Uplink Shared Channel (PUSCH).
Example A17 includes the method of Example A16. Further, a periodicity and an offset of the transmission of the calibration report is network configured.
Example A18 includes the method of Example A16. Further, a periodicity and an offset of the transmission of the calibration report is aligned with a Discontinuous Reception (DRX) cycle and an On Duration associated with the DRX cycle.
Example A19 includes the method of Example A1. Further, the calibration report is generated for aperiodic transmission using a Physical Uplink Shared Channel (PUSCH).
Example A20 includes the method of Example A1. Further, the method comprises: determining a first priority associated with the calibration report, determining a second priority associated with a second report, and determining whether to refrain from transmitting the calibration report or the second report based on a comparison of the first priority and the second priority.
Example A21 includes the method of Example A20. Further, the method comprises: determining that the second priority is lower than the first priority, and refraining from transmitting the second report.
Example A22 includes the method of Example A20. Further, the second report comprises at least one of a Layer 1 Signal to Interference plus Noise Ratio (L1-SINR) measurement or a Layer 1 Reference Signal Received Power (L1-RSRP) measurement, and wherein the first priority is equal to the second priority.
Example A23 includes the method of Example A20. Further, the second report does not include a Layer 1 Signal to Interference plus Noise Ratio (L1-SINR) measurement or a Layer 1 Reference Signal Received Power (L1-RSRP) measurement, and wherein the first priority is equal to the second priority.
Example A24 includes the method of Example A20. Further, the first report is a standalone time delay and frequency offset report, and wherein the first priority is lower than the second priority.
Example B1 may include one or more non-transitory computer-readable media including instructions to cause an electronic device, upon execution of the instructions by one or more processors of the electronic device, to perform one or more elements of a method described in or related to any of Examples A1-A24, or any other method or process described herein.
Example C1 may include an apparatus including logic, modules, and/or circuitry (e.g., processing circuitry) to perform one or more elements of a method described in or related to any of Examples A1-A24, or any other method or process described herein.
Example D1 may include a method, technique, or process as described in or related to any of Examples A1-A24, or portions or parts thereof.
Example D1 may include an apparatus including: one or more processors and one or more computer-readable media including instructions that, when executed by the one or more processors, cause the one or more processors to perform the method, techniques, or process as described in or related to any of Examples A1-A24, or portions thereof.
Example F1 may include a signal as described in or related to any of Examples A1-A24, or portions or parts thereof.
Example G1 may include a computer program including instructions, wherein execution of the program by a processing element is to cause the processing element to carry out the method, techniques, or process as described in or related to any of Examples A1-A24, or portions thereof. The operations or actions performed by the instructions executed by the processing element can include the methods of any one of Examples A1-A24.
Example H1 may include a method of communicating in a wireless network as shown and described herein.
Example I1 may include a system for providing wireless communication as shown and described herein. The operations or actions performed by the system can include the methods of any one of Examples A1-A24.
Example J1 may include a device for providing wireless communication as shown and described herein. The operations or actions performed by the device can include the methods of any one of Examples A1-A24.

The previously-described examples are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of Examples A1-A24.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method comprising:
measuring a first Channel State Information Reference Signal (CSI-RS) received from a first transmission reception point (TRP) of a plurality of TRPs;
measuring a second CSI-RS received from a second TRP of the plurality of TRPs;
determining a time delay and a frequency offset between the first TRP and the second TRP based on the first CSI-RS and the second CSI-RS; and
generating a calibration report comprising the determined time delay and the determined frequency offset for transmission to the first TRP and the second TRP.

2. The method of claim 1, wherein at least one of:
the first CSI-RS is received from a first pre-determined CSI-RS port associated with the first TRP, or
the second CSI-RS is received from a second pre-determined CSI-RS port associated with the second TRP.

3. The method of claim 1, wherein at least one of:
the first CSI-RS is received from a first CSI-RS port associated with the first TRP, wherein the first CSI-RS port is selected from among a first plurality of ports associated with the first TRP based on signal-to-noise ratios (SNRs) of the first plurality of ports, or
the second CSI-RS is received from a second CSI-RS port associated with the second TRP, wherein the second CSI-RS port is selected from among a second plurality of ports associated with the second TRP based on SNRs of the second plurality of ports.

4. The method of claim 3, wherein at least one of:
the first CSI-RS port is selected based on a first layer indicator (LI) indicating that the first CSI-RS has the highest SNR from among the first plurality of ports, or
the second CSI-RS port is selected based on a second LI indicating that the second CSI-RS has the highest SNR from among the second plurality of ports.

5. The method of claim 1, wherein at least one of:
the first CSI-RS is received periodically according to at least one of a first pre-determined periodicity or a first pre-determined offset associated with the first TRP, or
the second CSI-RS is received periodically according to at least one of a second pre-determined periodicity or a second pre-determined offset associated with the second TRP.

6. The method of claim 1, wherein at least one of:
the first CSI-RS is received aperiodically according to a first plurality of slots associated with a first set of frequencies, or
the second CSI-RS is received aperiodically according to a second plurality of slots associated with a second set of frequencies.

7. The method of claim 1, wherein at least one of:
the first CSI-RS is a first Tracking Reference Signal (TRS) associated with the first TRP, or
the second CSI-RS is a second TRS associated with the second TRP.

8. The method of claim 1, wherein the first CSI-RS is received from a first CSI-RS port associated with the first TRP, the first CSI-RS being configured based on a first Channel Measurement Resource (CMR) received from the first TRP, and
wherein the second CSI-RS is received from a second CSI-RS port associated with the second TRP, the second CSI-RS being configured based on a second CMR received from the second TRP, and
wherein at least one of:
the first CMR and the second CMR are received during a common Connected Mode Discontinuous Reception (CDRX) On-Duration, or
the first CMR is associated with a first phase, wherein the second CMR is associated with a second phase, and wherein the first phase and the second phase are continuous.

9. (canceled)

10. (canceled)

11. The method of claim 1, wherein determining the time delay and the frequency offset between the first TRP and the second TRP comprises:
selecting one of the first TRP or the second TRP as a reference TRP,
selecting the other one of the first TRP and the second TRP as a secondary TRP,
determining a time delay of the secondary TRP relative to the reference TRP, and
determining a frequency offset of the secondary TRP relative to the reference TRP,
wherein at least one of:
the reference TRP is indicated by a network configuration, or
the reference TRP is selected absent a network configuration indicating the reference TRP.

12. (canceled)

13. (canceled)

14. The method of claim 1, wherein the calibration report is a standalone report.

15. The method of claim 1, wherein the calibration report further comprises at least one of:
a Layer 1 Signal to Interference plus Noise Ratio (L1-SINR) measurement, or
a Time-Domain Channel Property (TDCP) measurement.

16. The method of claim 1, further comprising at least one of:
causing the calibration report to be transmitted periodically using a Physical Uplink Control Channel (PUCCH),
causing the calibration report to be transmitted semi-persistently using the PUCCH, or
causing the calibration report to be transmitted semi-persistently using a Physical Uplink Shared Channel (PUSCH).

17. The method of claim 16, wherein at least one of:
a periodicity and an offset of the transmission of the calibration report is network configured, or
a periodicity and an offset of the transmission of the calibration report is aligned with a Discontinuous Reception (DRX) cycle and an On Duration associated with the DRX cycle.

18. (canceled)

19. The method of claim 1, wherein the calibration report is generated for aperiodic transmission using a Physical Uplink Shared Channel (PUSCH).

20. The method of claim 1, further comprising:
determining a first priority associated with the calibration report,
determining a second priority associated with a second report, and
determining whether to refrain from transmitting the calibration report or the second report based on a comparison of the first priority and the second priority.

21. The method of claim 20, further comprising:
determining that the second priority is lower than the first priority, and
refraining from transmitting the second report.

22. The method of claim 20, wherein at least one of:
(i) the second report comprises at least one of a Layer 1 Signal to Interference plus Noise Ratio (L1-SINR) measurement or a Layer 1 Reference Signal Received Power (L1-RSRP) measurement, and wherein the first priority is equal to the second priority,
(ii) the second report does not include a Layer 1 Signal to Interference plus Noise Ratio (L1-SINR) measurement or a Layer 1 Reference Signal Received Power (L1-RSRP) measurement, and wherein the first priority is equal to the second priority, or
(iii) the first report is a standalone time delay and frequency offset report, and wherein the first priority is lower than the second priority.

23. (canceled)

24. (canceled)

25. (canceled)

26. (canceled)

27. An apparatus comprising processing circuitry configured to perform operations comprising:
measuring a first Channel State Information Reference Signal (CSI-RS) received from a first transmission reception point (TRP) of a plurality of TRPs;
measuring a second CSI-RS received from a second TRP of the plurality of TRPs;
determining a time delay and a frequency offset between the first TRP and the second TRP based on the first CSI-RS and the second CSI-RS; and
generating a calibration report comprising the determined time delay and the determined frequency offset for transmission to the first TRP and the second TRP.

28. One or more baseband processors configured to perform operations comprising:
measuring a first Channel State Information Reference Signal (CSI-RS) received from a first transmission reception point (TRP) of a plurality of TRPs;
measuring a second CSI-RS received from a second TRP of the plurality of TRPs;
determining a time delay and a frequency offset between the first TRP and the second TRP based on the first CSI-RS and the second CSI-RS; and
generating a calibration report comprising the determined time delay and the determined frequency offset for transmission to the first TRP and the second TRP.
